(19) United States
(12) Patent Application Publication
(10) Pub. No.: US 2024/0272632 A1
(43) Pub. Date: Aug. 15, 2024

(54) Method and System for Operating a Technical Device with a Model Based on Artificial Intelligence

(71) Applicant: Siemens Aktiengesellschaft, Muenchen (DE)

(72) Inventors: Jana EDER, Wien (AT); Thomas BIERWEILER, Stutensee (DE); Stephanie HOLLY, Stockerau (AT); Safoura REZAPOUR LAKANI, Wien (AT); Daniel SCHALL, Hollabrunn (AT); Stefan VON DOSKY, Karlsruhe (DE); Herbert GRIEB, Malsch (DE)

(21) Appl. No.: 18/435,429

(22) Filed: Feb. 7, 2024

(30) Foreign Application Priority Data
Feb. 9, 2023 (EP) 23155887

(51) Int. Cl. G05B 23/02; G05B 13/02

(52) U.S. Cl. CPC G05B 23/0283; G05B 13/0265

(57) ABSTRACT

A computer-implemented method for operating a technical device with a model based on artificial intelligence including detecting a first operating parameter of a reference apparatus in a first operating environment and a first permissible operating mode, detecting a second operating parameter of the reference apparatus in a second operating environment and a second permissible operating mode, performing a first Fourier transform for the first sensor signal and a second Fourier transform for the second sensor signal, determining a quotient from the first and second Fourier transforms as a transfer function, generating and training a first model based on artificial intelligence for the reference apparatus in the first operating environment, generating a second model based on artificial intelligence for the technical device in the second operating environment using the first model and applying the transfer function, and operating the technical device with the second model.

### BACKGROUND OF THE INVENTION

### 1. Field of the Invention

The invention relates to a computer-implemented method and a system for operating a technical device with a model based on artificial intelligence, and to a computer program product.

### 2. Description of the Related Art

Devices in an industrial setting are frequently operated with models based on artificial intelligence (AI) in order to perform a predictive maintenance. This is performed by a future operation being forecast with the aid of a model comprising current operating parameters, such as vibration data, acoustic data, and/or current or voltage data.

A model must be trained in a complex manner and is then frequently only valid for an installation of a device. If an identically constructed device is installed or arranged otherwise, then the model must be trained again in a complex manner in accordance with the prior art.

It is very difficult in the prior art to transfer an AI model, which was trained on a device, such as a pump, located in an environment, to the identical or similar devices in another environment.

The environment or the operating environment relates to the installed state, screw connection, floor condition or adjacent installations, for instance. The environment can influence the data and frequently results undesirably in other data distributions into the measured values.

### SUMMARY OF THE INVENTION

In view of the foregoing, it is an object of the invention to provide a solution in which a model can be reused for a device, i.e., independently of the operating environment, for instance, independently of the installation.

This and other objects and advantages are achieved in accordance with the invention by a computer-implemented method for operating a technical device with a model based on artificial intelligence, comprising:
a) detecting a first operating parameter of a reference apparatus that is constructed identically to the technical device, with the aid of a first measuring device in the form of a time-discrete first sensor signal in a first operating environment and a first permissible operating mode,
b) detecting a second operating parameter of the reference apparatus with the aid of a second measuring device in the form of a time-discrete second sensor signal in a second operating environment and a second permissible operating mode,
c) performing a first Fourier transform for the first sensor signal and a second Fourier transform for the second sensor signal via a computing apparatus, d) determining the quotient from the first Fourier transform and the second Fourier transform as a transfer function via the computing apparatus,
e) generating and training a first model based on artificial intelligence for the reference apparatus in the first operating environment via the computing apparatus,
f) generating a second model based on artificial intelligence for the technical device in the second operating environment using the first model and applying the transfer function via the computing apparatus, and
g) operating the technical device with the second model via the computing apparatus.

As a result, it is possible to train an AI model in a laboratory environment, for instance, and to transfer this AI model to a new installation at a high level of accuracy of the model, without the model having to be adjusted or retrained (Plug & Classify).

This enables the scaling of AI models in industrial applications because models can be used again without additional effort.

Even if, in the present context, the method for operating a technical device is described with a model based on artificial intelligence, reference is made to a statistical model in the cited method likewise being suitable for use and therefore representing an equivalent usage.

It is understood that the described methodology can be transferred from a single reference pump to any number of identically constructed pumps in different operating environments.

The term “an identically constructed technical device” includes all equivalent embodiments, which essentially correspond to one another or are similar in terms of function and actual configuration, i.e., have the same technical object and operating parameters (such as power consumption, output, weight, and/or volume) of a pump, for instance.

Operating environments can map the assembly of the technical device, for instance, as well as a cable routing or also influences from adjacent apparatuses.

The measuring device can be formed by measuring apparatuses with corresponding sensors.

The training of the reference apparatus can comprise all operating cases, both permissible operating modes and also impermissible operating modes, which can bring about an operating anomaly, for instance.

The Fourier transform can form a filter function that is based on average values of the sensor signals. The formation of average values is not necessarily required but further improves the accuracy of the obtained model.

In one embodiment of the invention, the first permissible operating mode to correspond to the second permissible operating mode. As a result, the accuracy of the second model can be further improved.

In another embodiment of the invention, the application of the transfer function comprises a multiplication in the frequency range. As a result, it is possible to easily improve the calculation because significantly fewer multiplication operations are required than with a multiplication in the time range. This operation corresponds to a convolution in the time range.

The objects and advantages in accordance with the invention are also achieved by a system for operating a technical device with a model based on artificial intelligence, where the system comprises a reference apparatus that is constructed identically to the technical device, a first measuring device for detecting a first operating parameter of the reference apparatus in a first operating environment and a first permissible operating mode, a second measuring device for detecting a second operating parameter of the reference apparatus in a second operating environment and a second permissible operating mode, and a computing apparatus including a processor and a memory, where the computing apparatus is also configured to operate the technical device and the system is configured to implement the method in accordance with the disclosed embodiments.

The objects and advantages in accordance with the invention are also achieved by a computer program product having machine-readable instructions stored therein which, when executed by a processing unit, trigger this to execute the method in accordance with the disclosed embodiments.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail below on the basis of an exemplary embodiment shown in the accompanying drawings, in which:

FIG. 1 shows a schematic representation of a system for operating a technical device with a model based on artificial intelligence with the respective input variables;

FIG. 2 shows a flow chart of the inventive method; and

FIG. 3 shows a simplified flow chart of the inventive method.

### DETAILED DESCRIPTION OF THE EXEMPLARY EMBODIMENTS

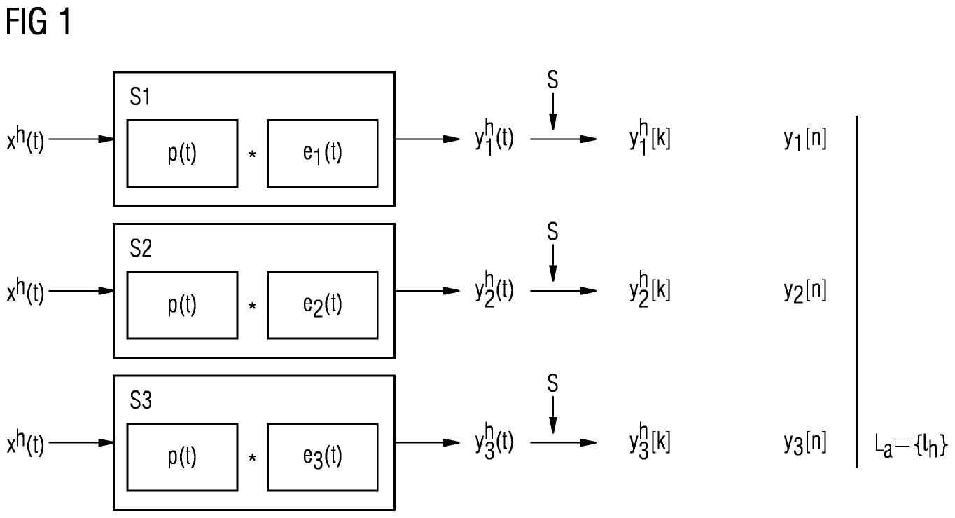

FIG. 1 shows a schematic representation of a system for operating a technical device with a model based on artificial intelligence with the respective input variables.

In this exemplary embodiment, three systems S1, S2, S3 are mapped by corresponding AI models.

The systems each comprise an identically constructed pump P, which is represented by a pump model p(t), and their own operating environment E1-E3, which are each mapped by their own operating environment models e₁(t), e₂(t), e₃(t).

The same input signals x^{h}(t) are supplied to the systems S1, S2, S3 and individual time-continuous output signals y₁^{h}(t), y₂^{h}(t), y₃^{h}(t) are formed by the systems S1-S3.

Time-discrete output signals y₁^{h}[k], y₂^{h}[k], y₃^{h}[k] are derived from the time-continuous output signals y₁^{h}(t), y₂^{h}(t), y₃^{h}(t) by scanning units s.

A condition for these method steps is that it applies to the systems S1, S2, S3, in particular to the operating environments Lₐ of the pumps P, that the elements of the time-discrete output signal y₁[n], y₂[n], y₃[n] are each detected in a permissible operating environment lₕ, i.e., do not represent an operating anomaly, for instance.

A permissible operating environment is understood to mean a permissible operating temperature range, for instance, a permissible operating humidity range, a permissible rotational speed range or torque range of a pump, a permissible current or power consumption.

Operating parameters are understood to mean, for instance, a temperature value, a current, a voltage, a vibration parameter, and/or an acoustic parameter for a technical device, which are determined with corresponding sensors or with the aid of indirect methods, such as imaging methods.

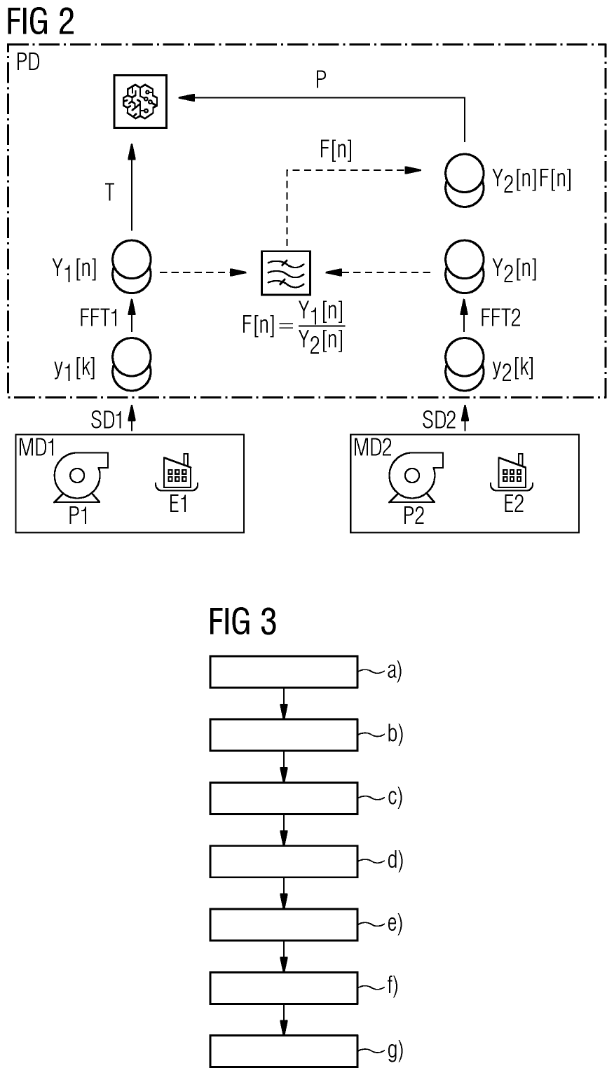

FIG. 2 represents an exemplary flowchart of the inventive method, where the embodiments of the preceding figure apply accordingly.

Time-discrete first sensor data SD1 is detected from a first pump P1 in a first operating environment E1, stored as a time discrete first sensor signal y1 [k] with k elements and a spectrum is calculated via a first Fourier transform FFT1, in particular via a Fast Fourier transform, and stored as a Fourier-transformed first sensor signal y1[k].

In the present context, a z-transform, a discrete Fourier transform or a discrete cosine transform can likewise be used instead of a Fast Fourier transform, for instance.

The first pump P1 forms a reference pump, on the basis of which a very accurate operating AI model can be calculated for further pumps without a model itself having to be trained again for these further pumps.

Time-discrete second sensor data SD2 is detected in a first operating environment E1 from a second pump P2 that is constructed identically to the first pump P1, stored as a time discrete second sensor signal y2[k] with k elements and a spectrum is calculated via a second Fourier transform FFT2, in particular via a Fast Fourier transform, and stored as a Fourier-transformed second sensor signal Y2[n].

The quotient of the Fourier-transformed first sensor signal Y1[n] and the Fourier-transformed second sensor signal Y2[n] is now formed by a computing apparatus including a processor and a memory and is stored as a transfer function F[n] with n elements.

If an operating AI model is now generated for the first pump P1 and trained in a training procedure T, in particular with permissible and impermissible operating environments, in which anomalies may occur, then this trained model can therefore be transferred to other pumps, such as in this example the second pump P2, without again training the model.

An AI model can now be determined for the second pump P2 with the aid of the transfer function F[n], without an AI model having to be trained for the second pump P2 and used for an accurate prediction P of the operating state of the second pump P2.

The figure also represents a corresponding system for operating a technical device P2 with a model based on artificial intelligence.

A reference apparatus in the form of the pump P1 is included, which is constructed identically to the technical device in the form of the pump P2,

Furthermore, a first measuring device MD1 for detecting a first operating parameter of the reference apparatus in a first operating environment and a first permissible operating mode is also included.

Moreover, a second measuring device MD2 for detecting a second operating parameter of the reference apparatus in a second operating environment and a second permissible operating mode.

A computing apparatus PD with a processor and a memory is also contained in the system and is configured to operate the technical device. It is clear that the computing apparatus PD can be formed as a distributed system.

FIG. 3 shows an exemplary simplified flow chart of the inventive method.

In the computer-implemented method for operating a technical device with a model based on artificial intelligence, the following steps are included:
a) detecting a first operating parameter of a reference apparatus P1 which is constructed identically to the technical device P2, aided by a first measuring device MD1, in the form of a time-discrete first sensor signal in a first operating environment E1 and a first permissible operating mode,
b) detecting a second operating parameter of the reference apparatus P1, aided by a second measuring means MD2, in the form of a time-discrete second sensor signal in a second operating environment E2 and a second permissible operating mode,
c) performing a first Fourier transform FFT1 for the first sensor signal and a second Fourier transform FFT1 for the second sensor signal via a computing apparatus PD,
d) determining the quotient from the first Fourier transform and the second Fourier transform as a transfer function F via the computing apparatus PD,
e) generating and training a first model based on artificial intelligence for the reference apparatus P1 in the first operating environment E1 via the computing apparatus PD,
f) generating a second model based on artificial intelligence for the technical device P2 in the second operating environment E2 using the first model and applying the transfer function F via the computing apparatus PD, and
g) operating the technical device P2 with the second model via the computing apparatus PD.

The first permissible operating mode corresponds, in this example to the second permissible operating mode, in order to obtain a particularly high accuracy of the pump model.

In a preferred exemplary embodiment, the application of the transfer function comprises a multiplication in the frequency range, as a result of which the number of necessary multiplications is reduced by a computing apparatus.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

### LIST OF REFERENCE CHARACTERS

e₁(t), e₂(t), e₃(t) Model for operating environment of the pump
E1, E2 Operating environment
F[n] Transfer function with n elements
FFT1, FFT2 Fast Fourier transform
Lₐ Operating environment of the pump
Iₕ Permissible operating environment for pump
MD1, MD2 Measuring means
P Prediction
p(t) Model for pump
P1, P2 Pump
PD Computing apparatus with processor and memory
S Scanning
S1-S3 System
SD1, SD2 Sensor data
T Training of the AI model
x^{h}(t) Input signal
y₁[k], y₂[k] Time-discrete sensor signal with k elements
Y₁[n], Y₂[n] Transformed sensor signal in the frequency range with n elements
y₁[n], y₂[n], y₃[n] Elements of the time-discrete output signal
y₁^{h}(t), y₂^{h}(t), y₃^{h}(t) output signal, time-continuous
y₁^{h}[k], y₂^{h}[k], y₃^{h}[k] Output signal, time-discrete

What is claimed is:

1. A computer-implemented method for operating a technical device with a model based on artificial intelligence, the method comprising:
a) detecting, via a first measurer, a first operating parameter of a reference apparatus which is constructed identically to the technical device, said first operating parameter comprising a time-discrete first sensor signal in a first operating environment and a first permissible operating mode;
b) detecting, via a second measuring, a second operating parameter of the reference apparatus comprising a time-discrete second sensor signal in a second operating environment and a second permissible operating mode;
c) performing a first Fourier transform for the first sensor signal and a second Fourier transform for the second sensor signal via a computing apparatus;
d) determining a quotient from the first Fourier transform and the second Fourier transform as a transfer function via the computing apparatus;
e) generating and training a first model based on the artificial intelligence for the reference apparatus in the first operating environment via the computing apparatus;
f) generating a second model based on the artificial intelligence for the technical device in the second operating environment utilizing the first model and applying the transfer function via the computing apparatus; and
g) operating the technical device with the second model via the computing apparatus.

2. The method as claimed in claim 1, wherein the first permissible operating mode corresponds to the second permissible operating mode.

3. The method as claimed in claim 1, wherein said applying the transfer function comprises a multiplication in the frequency range.

4. A system for operating a technical device with a model based on artificial intelligence, comprising
a reference apparatus which is constructed identically to the technical device;
a first measurer for detecting a first operating parameter of the reference apparatus in a first operating environment and a first permissible operating mode;
a second measurer for detecting a second operating parameter of the reference apparatus in a second operating environment and a second permissible operating mode;
a computing apparatus including a processor and memory;
wherein the computing apparatus is configured to operate the technical device; and
wherein the system is configured to:
a) detect, via the first measurer, the first operating parameter of the reference apparatus which is constructed identically to the technical device, said first operating parameter comprising a time-discrete first sensor signal in the first operating environment (E1) and the first permissible operating mode;
b) detect, via the second measuring, a second operating parameter of the reference apparatus comprising a time-discrete second sensor signal in the second operating environment and the second permissible operating mode;
c) perform a first Fourier transform for the first sensor signal and a second Fourier transform for the second sensor signal via the computing apparatus;
d) determine a quotient from the first Fourier transform and the second Fourier transform as a transfer function via the computing apparatus;
e) generate and train a first model based on the artificial intelligence for the reference apparatus in the first operating environment via the computing apparatus;
f) generate a second model based on the artificial intelligence for the technical device in the second operating environment utilizing the first model and apply the transfer function via the computing apparatus; and
g) operate the technical device with the second model via the computing apparatus.

5. A computer program product having machine-readable instructions stored therein which, when executed by a processor, causes operation of a technical device with a model based on artificial intelligence, the machine-readable instructions comprising:
a) program code for detecting, via a first measurer, a first operating parameter of a reference apparatus which is constructed identically to the technical device, said first operating parameter comprising a time-discrete first sensor signal in a first operating environment and a first permissible operating mode;
b) program code for detecting, via a second measuring, a second operating parameter of the reference apparatus comprising a time-discrete second sensor signal in a second operating environment and a second permissible operating mode;
c) program code for performing a first Fourier transform for the first sensor signal and a second Fourier transform for the second sensor signal via a computing apparatus;
d) program code for determining a quotient from the first Fourier transform and the second Fourier transform as a transfer function via the computing apparatus;
e) program code for generating and training a first model based on the artificial intelligence for the reference apparatus in the first operating environment via the computing apparatus;
f) program code for generating a second model based on the artificial intelligence for the technical device in the second operating environment utilizing the first model and applying the transfer function via the computing apparatus; and
g) program code for operating the technical device with the second model via the computing apparatus.
